(19) United States
(12) Patent Application Publication
(10) Pub. No.: US 2025/0252346 A1
(43) Pub. Date: Aug. 7, 2025

(54) DUAL-MODE FEDERATED LEARNING WITH SYNCHRONOUS AND ASYNCHRONOUS TRAINING

(71) Applicant: Cisco Technology, Inc., San Jose, CA (US)

(72) Inventors: Myungjin LEE, Bellevue, WA (US); Jaemin SHIN, Seattle, WA (US); Ramana Rao V. R. KOMPELLA, Foster City, CA (US)

(73) Assignee: Cisco Technology, Inc., San Jose, CA (US)

(21) Appl. No.: 18/435,620

(22) Filed: Feb. 7, 2024

(51) Int. Cl. G06N 20/00

(52) U.S. Cl. CPC G06N 20/00

(57) ABSTRACT

In one embodiment, an illustrative method herein comprises: determining, by a device, individual times for a set of trainer clients of a federated learning system to complete a round of machine learning model training and communication; computing, by the device, a sync time metric and a sync cost metric of a synchronous federated learning mode to reach model convergence based in part on the individual times; computing, by the device, an async time metric and an async cost metric of an asynchronous federated learning mode to reach model convergence based in part on the individual times and an asynchronous concurrency; and providing, by the device, a comparison between the synchronous federated learning mode and the asynchronous federated learning mode for the federated learning system according to the sync time metric, the sync cost metric, the async time metric, and the async cost metric.

### TECHNICAL FIELD

The present disclosure relates generally to computer networks, and, more particularly, to dual-mode federated learning with synchronous and asynchronous training.

### BACKGROUND

Federated learning has garnered increased interest in recent years due to its ability to train more robust artificial intelligence (AI) models, as well as its capability to protect privacy. For instance, consider the case of a set of different hospitals across the world, each of which stores X-ray images from their own patients. Sharing such medical information to the cloud for model training, or even between one another, may be undesirable (or even illegal), in many circumstances. With federated learning, however, models can be trained at each of the sites and using their own local data. The resulting model parameters can then be aggregated to form a global model that has been trained using the X-ray images across all of the hospitals, but in a manner that does not require those images to actually be shared.

Predominantly, existing federated learning approaches perform synchronous aggregation of client updates. As clients spend large portion of their time idling while waiting for other clients with synchronous federated learning, asynchronous approaches have also been proposed, which allows clients to continue their training operations independent of the status of other participants.

Numerous empirical studies have demonstrated that asynchronous federated learning can achieve faster training than synchronous federated learning. However, the relative “cost” of employing asynchronous versus synchronous remains ambiguous, and minimizing such costs can be important, particularly when there is a constrained budged involved.

### BRIEF DESCRIPTION OF THE DRA WINGS

The embodiments herein may be better understood by referring to the following description in conjunction with the accompanying drawings in which like reference numerals indicate identically or functionally similar elements, of which:

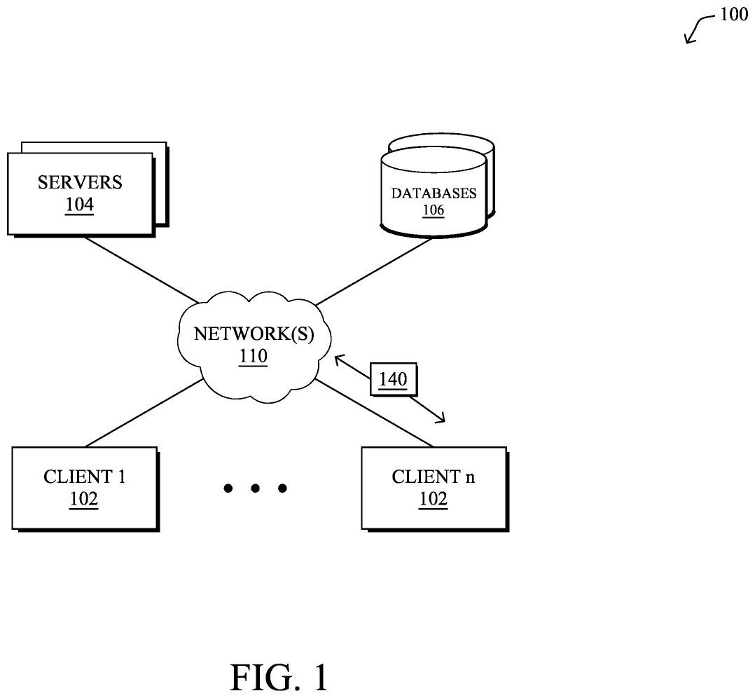

FIG. 1 illustrates an example computing system;

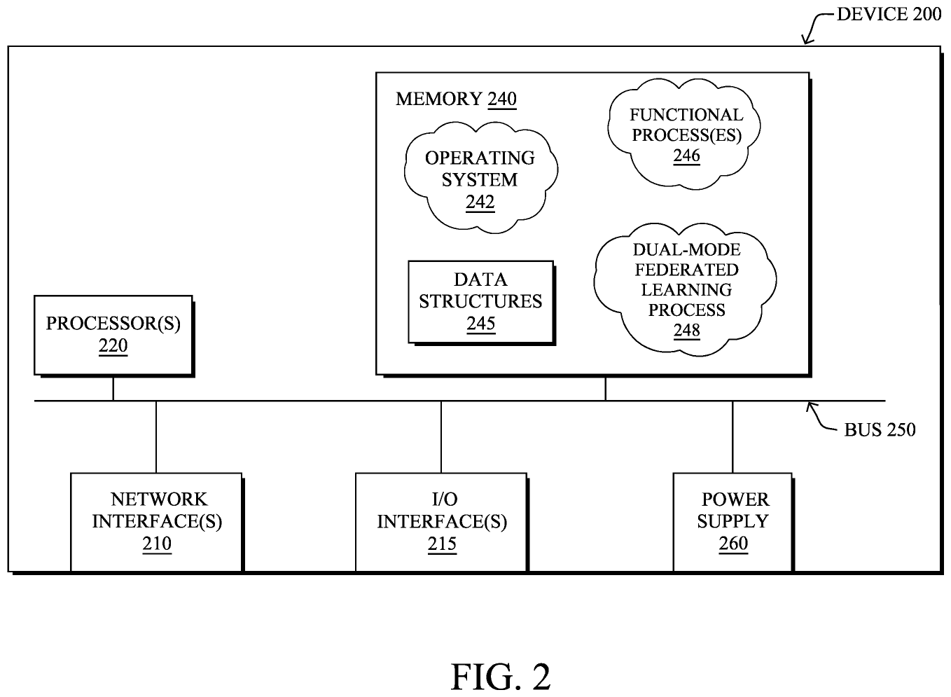

FIG. 2 illustrates an example network device/node;

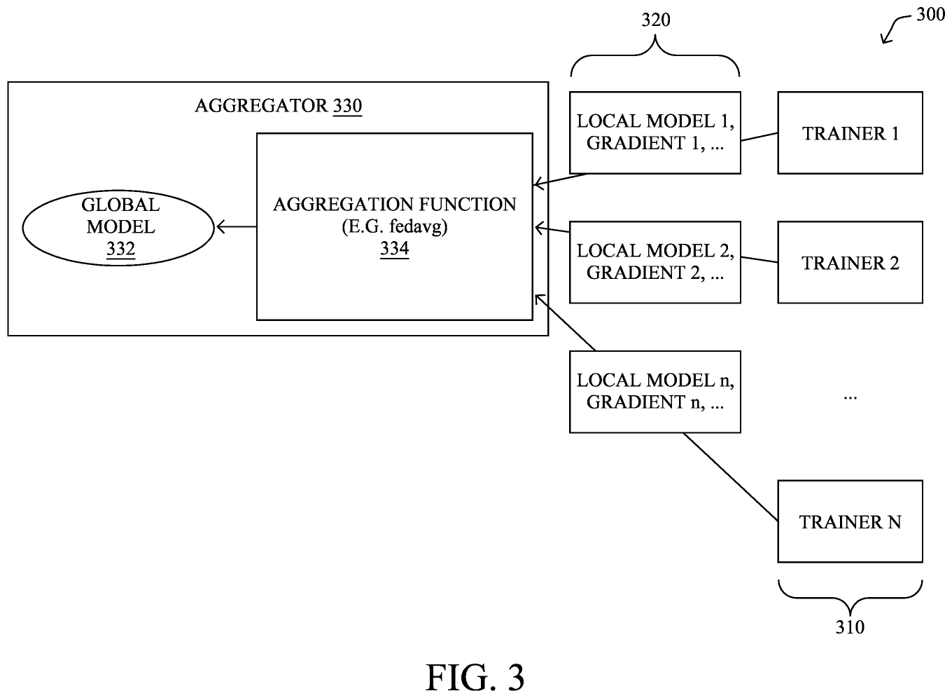

FIG. 3 illustrates an example federated learning architecture;

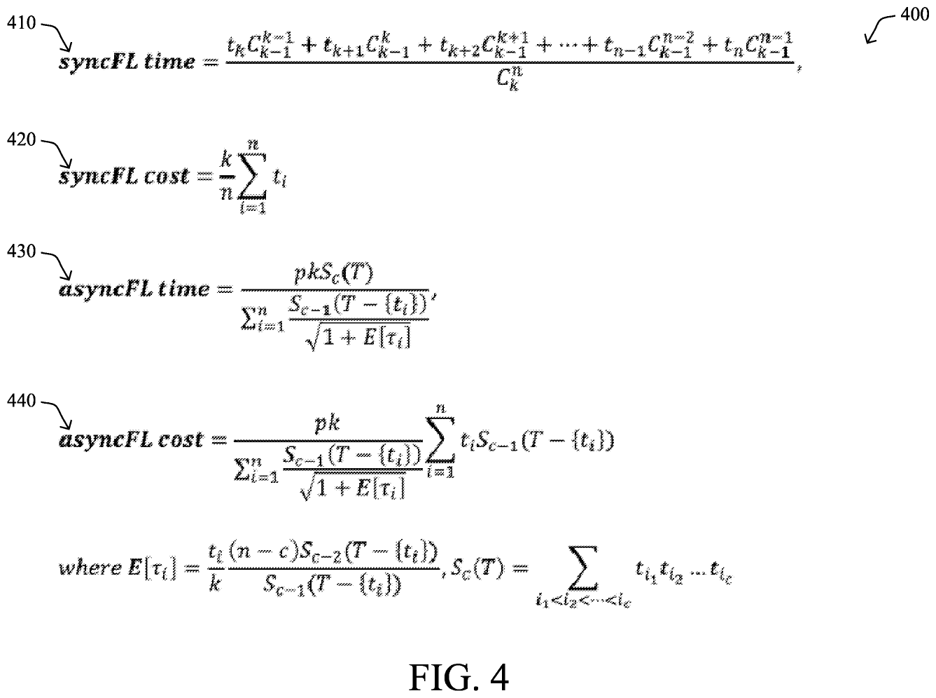

FIG. 4 illustrates an example formulaic determination for the time and cost of asynchronous federated learning and synchronous federated learning to reach model convergence;

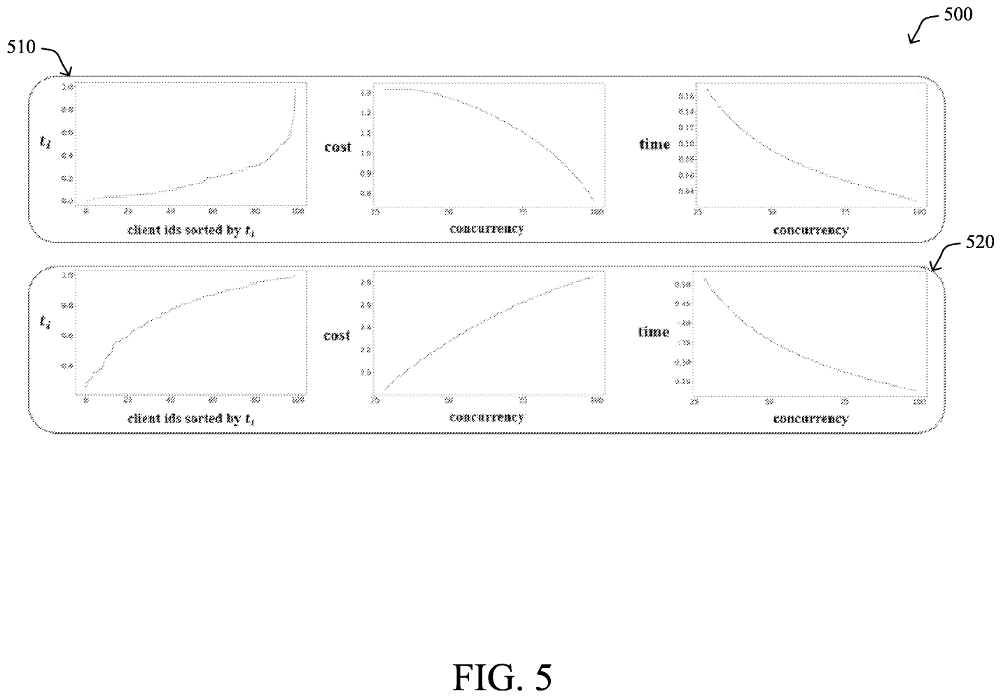

FIG. 5 illustrates examples of a formulaic cost and time result on asynchronous federated learning compared to synchronous federated learning, from two different sets of trainer clients;

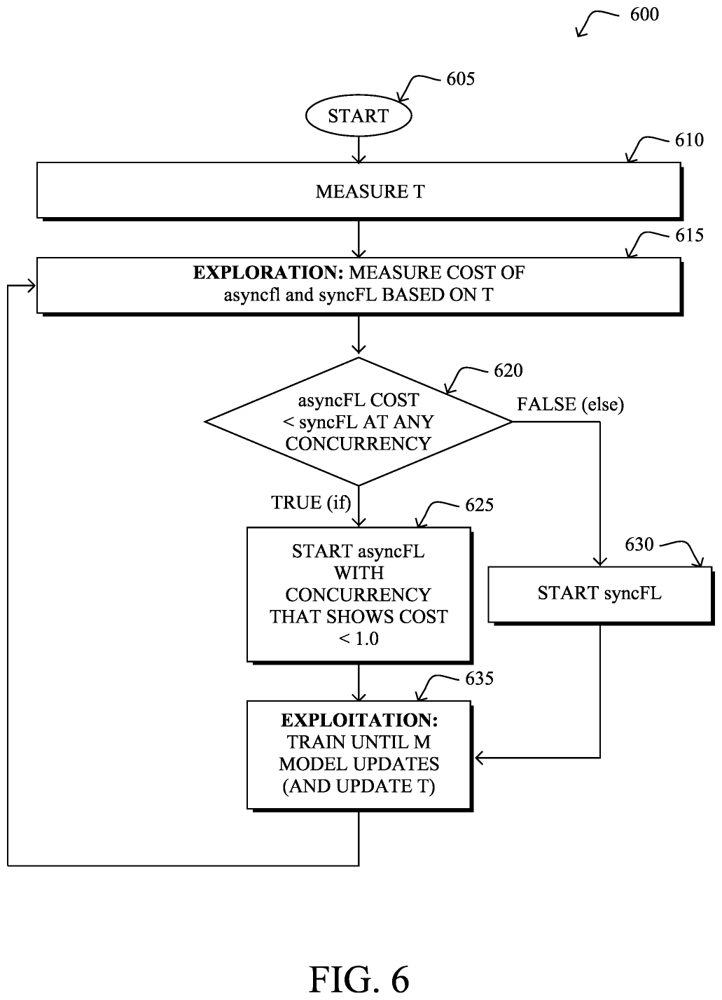

FIG. 6 illustrates an example procedure for exploration and exploitation as federated learning proceeds in order to dynamically switch between synchronous federated learning and asynchronous federated learning; and

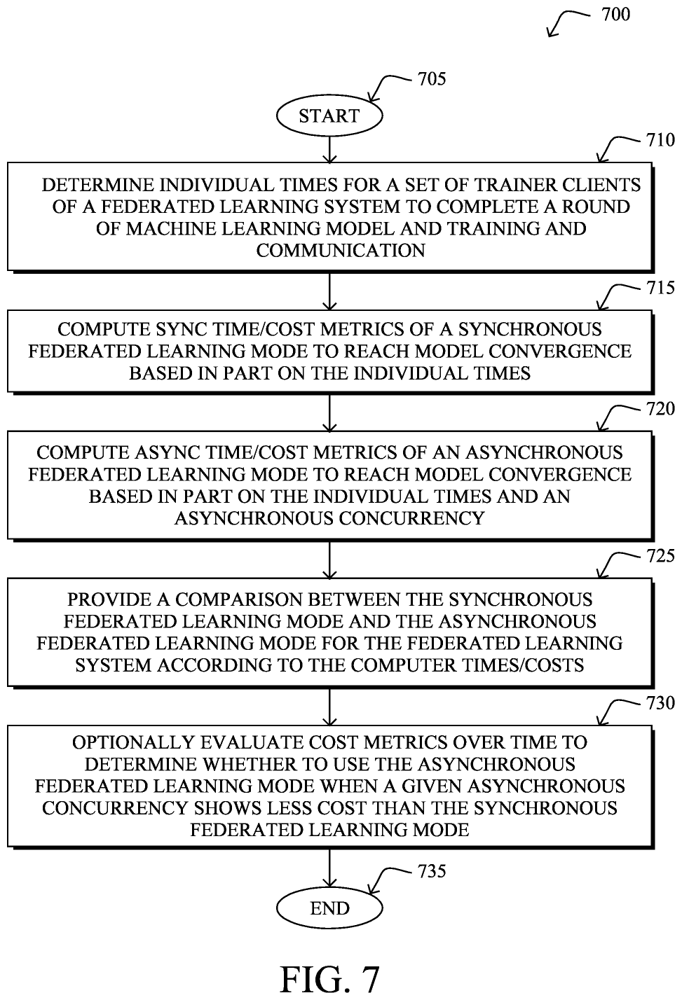

FIG. 7 illustrates an example procedure for dual-mode federated learning with synchronous and asynchronous training.

### DESCRIPTION OF EXAMPLE EMBODIMENTS

### Overview

According to one or more embodiments of the disclosure, an illustrative method herein comprises: determining, by a device, individual times for a set of trainer clients of a federated learning system to complete a round of machine learning model training and communication; computing, by the device, a sync time metric and a sync cost metric of a synchronous federated learning mode to reach model convergence based in part on the individual times; computing, by the device, an async time metric and an async cost metric of an asynchronous federated learning mode to reach model convergence based in part on the individual times and an asynchronous concurrency; and providing, by the device, a comparison between the synchronous federated learning mode and the asynchronous federated learning mode for the federated learning system according to the sync time metric, the sync cost metric, the async time metric, and the async cost metric.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a dual-mode federated learning process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

In various implementations, as detailed further below, dual-mode federated learning process (process 248) may include computer executable instructions that, when executed by processor(s) 220, cause device 200 to perform the techniques described herein. To do so, in some implementations, process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) ANNs (e.g., for non-linear models), replicating reservoir networks (e.g., for non-linear models, typically for time series), random forest classification, or the like.

In further implementations, process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, process 248 may use a generative model to generate synthetic network traffic based on existing user traffic to test how the network reacts. Example generative approaches can include, but are not limited to, generative adversarial networks (GANs), large language models (LLMs), other transformer models, and the like. In some instances, process 248 may be executed to intelligently route LLM workloads across executing nodes (e.g., communicatively connected GPUs clustered into domains).

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives to the sum of true and false positives.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

—Dual-Mode Federated Learning with Sync and Async Training—

As noted above, numerous empirical studies have demonstrated that asynchronous federated learning can achieve faster training than synchronous federated learning. However, the relative “cost” of employing asynchronous versus synchronous remains ambiguous. In this context, the term “cost” is used to describe the runtime experienced by federated learning clients, encompassing both the training process and model communication. As also noted above, minimizing such costs can be important, particularly when there is a constrained budged involved, such as in the case of Cloud computing services (e.g., Amazon Web Services, AWS). Similarly, when federated learning is implemented on mobile devices, including smartphones, extended runtime can significantly impact the user's quality of experience (QoE).

Synchronous FL progresses in rounds, where the number of active clients increases at the start of a round as clients join the cohort and gradually decreases towards the round's end due to stragglers. In asynchronous FL, the number of active clients remains relatively constant over time; as clients complete training and upload their results, other clients take their place.

Notably, “concurrency” refers to the simultaneous (parallel) training of multiple trainer clients. Generally, increasing concurrency speeds up the training process. However, when examining the FedAvg asynchronous Federated Learning (FL) algorithm in terms of the number of communication rounds and client updates needed to achieve a target accuracy, it has been observed that there are diminishing returns from increasing concurrency for synchronous FL in terms of training time. (This behavior is akin to observations in conventional Stochastic Gradient Descent (SGD) training, where increasing the batch size eventually results in diminishing returns.) In particular, as concurrency increases, synchronous FL becomes less data-efficient. The server learning rate and hyperparameters are adjusted separately for each concurrent training user count, and the number of client updates does not account for any overhead related to over-selection.

The techniques herein, therefore, allow for the evaluation of the costs associated with performing asynchronous federated learning and selecting between asynchronous and synchronous modes, accordingly.

Specifically, according to one or more embodiments of the disclosure as described in detail below, an illustrative method herein comprises: determining individual times for a set of trainer clients of a federated learning system to complete a round of machine learning model training and communication; computing a sync time metric and a sync cost metric of a synchronous federated learning mode to reach model convergence based in part on the individual times; computing an async time metric and an async cost metric of an asynchronous federated learning mode to reach model convergence based in part on the individual times and an asynchronous concurrency; and providing a comparison between the synchronous federated learning mode and the asynchronous federated learning mode for the federated learning system according to the sync time metric, the sync cost metric, the async time metric, and the async cost metric.

FIG. 3 illustrates an example federated learning architecture 300. In particular, a federated learning system typically involves N-number of trainer clients 310 (e.g., “trainer 1”, “trainer 2”, . . . “trainer N”) that each perform local training before sending the results 320 (e.g., “local model 1, gradient 1, . . . ” for trainers 1-N) to an aggregator 330, which aggregates the results into a global model 332 using an aggregation function 334 (e.g., FedAvg or otherwise, as described below).

More complex federated learning architectures may include intermediate aggregators that each aggregate the results of a subset of the trainer clients before sending their own results to the global aggregator. Other architectures may also have different trainer clients share results with one another, among others.

Operationally, the techniques herein formulate the time and cost of asynchronous federated learning (“async FL” or simply “async”) and synchronous federated learning (“sync FL” or simply “sync”) to reach model convergence.

FIG. 4 illustrates an example formulaic determination 400 for the time and cost of async FL and sync FL to reach model convergence. In particular, the techniques herein calculate the following metrics:
syncFL time 410 as shown (e.g., a representative calculation of a time (e.g., average) for a trainer client to complete a round from among a particular set of trainer clients within a synchronous federated learning system);
syncFL cost 420 as shown (e.g., a representative calculation of an aggregate time of these trainer clients to complete their rounds; that is, an aggregate runtime experienced for training and model communication by the system using synchronous federated learning);
asyncFL time 430 as shown (e.g., a representative calculation of a time for a trainer client to complete a round in an asynchronous federated learning system); and
async FL cost 440 as shown (e.g., a representative calculation of an aggregate runtime experienced for training and model communication by the system using asynchronous federated learning).

The formulation in FIG. 4 is specifically based on the following setup and assumptions:
1. There are a total number n FL clients.
2. Each trainer takes t_i time (i={1, . . . , n}) to complete a round (model download->training->model upload).
3. [T={t_1, t_2, . . . , t_n}, t] _1≤t_2< . . . ≤t_n without losing generality.
4. SyncFL: In one implementation, the techniques herein may randomly sample and aggregate k trainers at a round (a “C” fraction of trainer clients each round), such as based on the known “FedAvg” algorithm.
5. AsyncFL: In one implementation, the techniques herein may aggregate the model with k model updates (agg_goal), training a set “S” of c (concurrency) trainer clients at a time, such as based on the known “FedBuff” algorithm.
6. It takes performance of p model updates to reach the model convergence. AsyncFL's model update may be penalized by a staleness penalty 1/√(1+τ_i(t)), where τ_i(t)=version difference of a local model of trainer i versus the global model at time t.

According to the present disclosure, as shown in FIG. 4, the techniques herein formulate the time and cost of both synchronous federated learning and asynchronous federated learning, which, in one example implementation, uses FedAvg as the algorithm for syncFL and FedBuff as the algorithm for asyncFL. In general, in FedAvg for syncFL, for instance, a central server coordinates the distribution and aggregation of model weights with client devices in structured rounds. FedBuff, on the other hand for asyncFL, employs a fixed-size server buffer that stores the client updates and performs aggregation when the buffer is full.

Based on the formulated result calculated in FIG. 4, the techniques herein may then provide guidance as to which particular mode to operate, syncFL or asyncFL, for a given set of trainer clients. That is, a federated learning deployer, who holds T={t_1, t_2, . . . , t_n}, which is the individual clients' time to complete a round, could use the formulation to understand how the cost and time differs between asynchronous and synchronous modes of operation.

FIG. 5 illustrates examples 500 of a formulaic cost and time result on asynchronous federated learning compared to synchronous federated learning, from two different sets of trainer clients (i.e., from two different T). In particular, the examples may be displayed on a graphical user interface (GUI) in graphical form, such as shown, or in any other digestible format. The example 510 on the top shows that the cost of asynchronous federated learning could be lower than synchronous federated learning for that set of trainer clients if the concurrency is high (i.e., concurrency goes up, cost and time go down, in the example). However, the example 520 on the bottom shows that the cost of asynchronous federated learning is always higher than synchronous federated learning, and high concurrency results in higher cost (i.e., concurrency goes up, and cost goes up (though time goes down).) Based on such information, the federated learning deployers on the example 510 could choose asynchronous mode for cost-effective federated learning, and the deployers on the example 520 could instead choose synchronous mode for their cost-effective federated learning.

According to one or more embodiments of the present disclosure, as federated learning proceeds, the federated learning deployer could monitor the time information T={t_1, t_2, . . . , t_n} on clients in order to dynamically switch between synchronous and asynchronous federated learning modes. Illustratively, this may be accomplished via exploration and exploitation phases, such as shown in procedure 600 of FIG. 6.

As shown, the procedure starts in step 605, and then federated learning deployers could measure T on every client in step 610 before starting training. However, as this step incurs additional latency overhead, step 615 could instead simply start with either synchronous or asynchronous, and then naturally measure T during the training process. This is an “exploration” phase in the techniques herein. After the exploration phase (step 615), the system may then determine whether there is any concurrency that shows less cost than synchronous federated learning in step 620 (i.e., if asyncFL cost<syncFL at any concurrency). If True, then in step 625 the system starts asynchronous mode with the concurrency that shows lowest cost and time (i.e., cost<1.0). Otherwise (False in step 620), the system starts synchronous mode in step 630. After either mode is determined, then in step 635 the system continues training for M model updates (and updating T), which is an “exploitation” phase in the techniques herein. Here, M is a parameter that could be configured by the federated learning deployers.

In closing, FIG. 7 illustrates an example simplified procedure for dual-mode federated learning with synchronous and asynchronous training in accordance with one or more embodiments described herein. For example, a non-generic, specifically configured device (e.g., device 200, an apparatus) may perform procedure 700 by executing stored instructions (e.g., process 248). The procedure 700 may start at step 705, and continues to step 710, where, as described in greater detail above, the techniques herein determine individual times (e.g., t_i) for a set of trainer clients of a federated learning system (e.g., a total number n trainer clients) to complete a round of machine learning model training and communication.

In step 715, the techniques herein compute a sync time metric (e.g., syncFL time 410) and a sync cost metric (e.g., syncFL cost 420) of a synchronous federated learning mode to reach model convergence based in part on the individual times. Notably, in one embodiment, the techniques herein may randomly sample and aggregate times from a selected number of trainer clients (e.g., k) from a plurality of trainer clients (e.g., n) of the federated learning system as the set of trainer clients.

In one implementation, computing the sync time metric is based in part on an average time of the individual times and computing the sync cost metric is based in part on a total aggregate time of the individual times. For instance, in one embodiment, the techniques herein may use a FedAvg algorithm for computing the sync time metric and the sync cost metric of the synchronous federated learning mode, accordingly, as described above.

In step 720 the techniques herein may also compute an async time metric (e.g., asyncFL time 430) and an async cost metric (async FL cost 440) of an asynchronous federated learning mode to reach model convergence based in part on the individual times and an asynchronous concurrency. In one implementation, computing the async time metric and the async cost metric is based in part on an asynchronous federated learning aggregation model with a selected number (e.g., k) of model updates and a selected concurrency (e.g., c) of trainer clients training at a same time. Also, in one implementation, computing the async time metric and the async cost metric is based in part on a given number of model updates (e.g., p) to perform to reach model convergence. In one embodiment, the techniques herein may also penalize the async time metric and the async cost metric by a staleness penalty (e.g., 1/√(1+τ_i(t))) based on a version difference of local trainer models versus a global model at a given time. As described above, also, the techniques herein may use a FedBuff algorithm for computing the async time metric and the async cost metric of the asynchronous federated learning mode, accordingly.

Note that as detailed above, the sync cost metric and the async cost metric may generally be respectively representative of a total runtime experienced by the set of trainer clients of the federated learning system to reach model convergence via the synchronous federated learning mode and the asynchronous federated learning mode.

In step 725, the techniques herein may then provide a comparison between the synchronous federated learning mode and the asynchronous federated learning mode for the federated learning system according to the sync time metric, the sync cost metric, the async time metric, and the async cost metric. For example, in one implementation, the techniques herein may display a graphical user interface (e.g., examples 500) indicative of the comparison between one or both of the sync time metric and the sync cost metric versus one or both of the async time metric and the async cost metric in relation to the asynchronous concurrency. In another implementation, the techniques herein may otherwise present a suggestion to use either the synchronous federated learning mode or the asynchronous federated learning mode based on one or both of the sync time metric and the sync cost metric versus one or both of the async time metric and the async cost metric.

In certain embodiments, in optional step 730, the techniques herein may further evaluate the sync cost metric and the async cost metric over a length of time of operating the federated learning system in order to determine whether a given asynchronous concurrency evaluated shows less cost than the synchronous federated learning mode, such as described with reference to procedure 600 above. As such, also in optional step 730, in response to the given asynchronous concurrency showing less cost than the synchronous federated learning mode, the techniques herein may then use the asynchronous federated learning mode with the given asynchronous concurrency, accordingly. (Or, as described above, may otherwise continue to use the synchronous mode, and may further continue to evaluate over more time.)

Procedure 700 may end at step 735.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process, when executed, configured to: determine individual times for a set of trainer clients of a federated learning system to complete a round of machine learning model training and communication; compute a sync time metric and a sync cost metric of a synchronous federated learning mode to reach model convergence based in part on the individual times; compute an async time metric and an async cost metric of an asynchronous federated learning mode to reach model convergence based in part on the individual times and an asynchronous concurrency; and provide a comparison between the synchronous federated learning mode and the asynchronous federated learning mode for the federated learning system according to the sync time metric, the sync cost metric, the async time metric, and the async cost metric.

In still other implementations, a tangible, non-transitory, computer-readable medium storing program instructions that cause a device to execute a process comprising:

determining individual times for a set of trainer clients of a federated learning system to complete a round of machine learning model training and communication; computing a sync time metric and a sync cost metric of a synchronous federated learning mode to reach model convergence based in part on the individual times; computing an async time metric and an async cost metric of an asynchronous federated learning mode to reach model convergence based in part on the individual times and an asynchronous concurrency; and providing a comparison between the synchronous federated learning mode and the asynchronous federated learning mode for the federated learning system according to the sync time metric, the sync cost metric, the async time metric, and the async cost metric.

The techniques described herein, therefore, provide for dual-mode federated learning with synchronous and asynchronous training. Various approaches have been proposed to support asynchronous training in federated learning systems, but none focus on operating among syncFL and asyncFL by formulating and comparing their respective times and costs. For example, asynchronous aggregation federated learning (AAFL) leverages reinforcement learning to dynamically determine the optimal fraction of client updates to perform an asynchronous aggregation. Semi-Asynchronous Federated Averaging (SAFA) is another FL scheme, which operates asynchronous federated learning but employs synchronous time points to aggregation model updates, where clients are not required to update at every synchronization round. The techniques herein, on the other hand, which illustratively use FedBuff (the most commonly used algorithm for asyncFL), formulate a comparative result to guide deployers as to whether to operate syncFL or asyncFL for specific implementations. Further, Federated learning with Asynchronous Tiers (FedAT) is a method that addresses the challenges of stragglers by dividing the clients into tiers based on their communication latency, and performing intra-tier syncFL and cross-tier asyncFL. The techniques herein, on the other hand, work on clients without tier grouping, and adopt FedBuff as an asyncFL algorithm to again guides which one to operate among syncFL and asyncFL based on the formulated result, accordingly.

Illustratively, the techniques described herein may be performed by hardware, software, and/or firmware, (e.g., an “apparatus”) such as in accordance with the dual-mode federated learning process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly. Also, while certain embodiments are described herein with respect to using certain models for particular purposes, the models are not limited as such and may be used for other functions, in other embodiments.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
determining, by a device, individual times for a set of trainer clients of a federated learning system to complete a round of machine learning model training and communication;
computing, by the device, a sync time metric and a sync cost metric of a synchronous federated learning mode to reach model convergence based in part on the individual times;
computing, by the device, an async time metric and an async cost metric of an asynchronous federated learning mode to reach model convergence based in part on the individual times and an asynchronous concurrency; and
providing, by the device, a comparison between the synchronous federated learning mode and the asynchronous federated learning mode for the federated learning system according to the sync time metric, the sync cost metric, the async time metric, and the async cost metric.

2. The method of claim 1, wherein computing the sync time metric is based in part on an average time of the individual times and wherein computing the sync cost metric is based in part on a total aggregate time of the individual times.

3. The method of claim 1, wherein computing the async time metric and the async cost metric is based in part on an asynchronous federated learning aggregation model with a selected number of model updates and a selected concurrency of trainer clients training at a same time.

4. The method of claim 1, wherein computing the async time metric and the async cost metric is based in part on a given number of model updates to perform to reach model convergence.

5. The method of claim 1, further comprising:
penalizing the async time metric and the async cost metric by a staleness penalty based on a version difference of local trainer models versus a global model at a given time.

6. The method of claim 1, wherein computing the sync time metric and the sync cost metric comprises:
randomly sampling and aggregating times from a selected number of trainer clients from a plurality of trainer clients of the federated learning system as the set of trainer clients.

7. The method of claim 1, further comprising:
evaluating the sync cost metric and the async cost metric over a length of time of operating the federated learning system;
determining whether a given asynchronous concurrency evaluated shows less cost than the synchronous federated learning mode; and
using, in response to the given asynchronous concurrency showing less cost than the synchronous federated learning mode, the asynchronous federated learning mode with the given asynchronous concurrency.

8. The method of claim 1, wherein providing the comparison comprises:
displaying a graphical user interface indicative of the comparison between one or both of the sync time metric and the sync cost metric versus one or both of the async time metric and the async cost metric in relation to the asynchronous concurrency.

9. The method of claim 1, wherein providing the comparison comprises:
presenting a suggestion to use either the synchronous federated learning mode or the asynchronous federated learning mode based on one or both of the sync time metric and the sync cost metric versus one or both of the async time metric and the async cost metric.

10. The method of claim 1, wherein the sync cost metric and the async cost metric are respectively representative of a total runtime experienced by the set of trainer clients of the federated learning system to reach model convergence via the synchronous federated learning mode and the asynchronous federated learning mode.

11. The method of claim 1, further comprising:
using a FedAvg algorithm for computing the sync time metric and the sync cost metric of the synchronous federated learning mode.

12. The method of claim 1, further comprising:
using a FedBuff algorithm for computing the async time metric and the async cost metric of the asynchronous federated learning mode.

13. An apparatus, comprising:
one or more network interfaces to communicate with a network;
a processor coupled to the one or more network interfaces and configured to execute one or more processes; and
a memory configured to store a process that is executable by the processor, the process, when executed, configured to:
determine individual times for a set of trainer clients of a federated learning system to complete a round of machine learning model training and communication;
compute a sync time metric and a sync cost metric of a synchronous federated learning mode to reach model convergence based in part on the individual times;
compute an async time metric and an async cost metric of an asynchronous federated learning mode to reach model convergence based in part on the individual times and an asynchronous concurrency; and
provide a comparison between the synchronous federated learning mode and the asynchronous federated learning mode for the federated learning system according to the sync time metric, the sync cost metric, the async time metric, and the async cost metric.

14. The apparatus of claim 13, wherein the sync time metric is computed based in part on an average time of the individual times and wherein computing the sync cost metric is based in part on a total aggregate time of the individual times.

15. The apparatus of claim 13, wherein the async time metric and the async cost metric are computed based in part on an asynchronous federated learning aggregation model with a selected number of model updates and a selected concurrency of trainer clients training at a same time.

16. The apparatus of claim 13, wherein the process, when executed, is further configured to:
penalize the async time metric and the async cost metric by a staleness penalty based on a version difference of local trainer models versus a global model at a given time.

17. The apparatus of claim 13, wherein the process, when executed to compute the sync time metric and the sync cost metric, is configured to:
randomly sample and aggregate times from a selected number of trainer clients from a plurality of trainer clients of the federated learning system as the set of trainer clients.

18. The apparatus of claim 13, wherein the process, when executed, is further configured to:
evaluate the sync cost metric and the async cost metric over a length of time of operating the federated learning system;
determine whether a given asynchronous concurrency evaluated shows less cost than the synchronous federated learning mode; and
use, in response to the given asynchronous concurrency showing less cost than the synchronous federated learning mode, the asynchronous federated learning mode with the given asynchronous concurrency.

19. The apparatus of claim 13, wherein the process, when executed to provide the comparison, is configured to:
display a graphical user interface indicative of the comparison between one or both of the sync time metric and the sync cost metric versus one or both of the async time metric and the async cost metric in relation to the asynchronous concurrency.

20. A tangible, non-transitory, computer-readable medium storing program instructions that cause a device to execute a process comprising:
determining individual times for a set of trainer clients of a federated learning system to complete a round of machine learning model training and communication;
computing a sync time metric and a sync cost metric of a synchronous federated learning mode to reach model convergence based in part on the individual times;
computing an async time metric and an async cost metric of an asynchronous federated learning mode to reach model convergence based in part on the individual times and an asynchronous concurrency; and
providing a comparison between the synchronous federated learning mode and the asynchronous federated learning mode for the federated learning system according to the sync time metric, the sync cost metric, the async time metric, and the async cost metric.
